(19) United States
(12) Patent Application Publication
(10) Pub. No.: US 2014/0380443 A1
(43) Pub. Date: Dec. 25, 2014

(54) NETWORK CONNECTION IN A WIRELESS COMMUNICATION DEVICE

(71) Applicant: Cambridge Silicon Radio Limited, Cambridge (GB)

(72) Inventors: Jeremy Stark, Ely (GB); Joseph Decuir, Issaqua, WA (US); Marco Ferri, Cambridge (GB)

(21) Appl. No.: 13/925,027

(22) Filed: Jun. 24, 2013

(51) Int. Cl. H04W 12/08

(52) U.S. Cl. CPC H04W 12/08
USPC 726/7

(57) ABSTRACT

The secure sharing of network security credentials allows a wireless communication device to connect to a network. By sharing the security credentials out of band, using a different communications protocol (such as Bluetooth or Bluetooth Low Energy), devices can be easily and securely connected to the network.

### TECHNICAL FIELD

The present invention relates to communications devices and associated methods. More particularly, the present invention relates to communications devices and methods for more easily connecting to a network.

### BACKGROUND

Home networking is on the increase for non-traditional appliances. For example, it is well known that computing devices such as laptops, smart phones and the like possess radios for connecting to WiFi and other networks. However, increasingly devices such as loudspeakers, televisions, and media players also possess radios for connecting to such networks.

Public WiFi networks are typically open, in that any suitable WiFi device can connect to an access point of the network without requiring permission or a password. Charges may apply for connection through to the Internet, but the WiFi network itself is free to connect to. Private WiFi networks, such as for homes or businesses, usually apply one or more security measures to prevent unauthorised users from connecting. Several security protocols are known, including WEP (Wired Equivalent Privacy), WPA (WiFi Protected Access) and WPA2 (WiFi Protected Access II). All of these protocols operate by encrypting packets with one or more encryption keys, which are generated using a password or passphrase.

Security is enhanced by choosing a password or passphrase which is relatively long (13 characters is recommended), which comprises a mix of different character types (i.e. numbers, upper- and lower-case letters, symbols, etc), and which does not include dictionary words. The complexity of many passphrases makes correctly entering them difficult. Repeated failed attempts to access a network can be frustrating to the end user, and also lead to unnecessarily increased traffic on the network. The process of entering a passphrase can be particularly cumbersome and difficult when performed using a device without a keyboard, such as in the majority of non-traditional devices listed above. An alternative method of connecting to the network is required.

### SUMMARY OF INVENTION

According to a first aspect of the present invention, there is provided a method in a first wireless communication device, comprising: establishing a first wireless connection with a second wireless communication device using a first communication protocol; enquiring over the first wireless connection if the second device is connected to a network via a second communication protocol; if the second device is connected to a network via the second communication protocol, receiving, over the first wireless connection, security credentials of the connection between the second device and the network; and using the security credentials to establish a second wireless connection with the network using the second communication protocol.

According to a second aspect of the present invention, there is provided a method in a second wireless communication device, comprising: establishing a first wireless connection with a first device using a first communication protocol; receiving a message from the first device enquiring whether the second wireless communication device has a second wireless connection to a network via a second communication protocol; and checking whether the second wireless communication device has the second wireless connection and, if so, sending the security credentials of the second wireless connection to the first device using the first communication protocol.

According to a third aspect of the present invention, there is provided a communications device, comprising: a first radio for communicating with a second wireless communication device using a first communication protocol; and a second radio for communicating with a network using a second communication protocol; the communications device being configured to: use the first radio to enquire whether the second device is connected to a network via the second communication protocol; if the second device is connected to a network via the second communication protocol, receive, using the first radio, security credentials of the connection between the second device and the network; and use the security credentials and the second radio to establish a wireless connection with the network using the second communication protocol.

According to a fourth aspect of the present invention, there is provided a communications device, comprising: a first radio for communicating with a second wireless communication device using a first communication protocol; and a second radio for communicating with a network using a second communication protocol; the communications device being configured to: use the first radio to receive a message from the second wireless communication device enquiring whether the communications device has a wireless connection to a network via the second communication protocol; and check whether the communications device has the wireless connection and, if so, send the security credentials of the wireless connection to the first device using the first communication protocol.

Embodiments of the present invention thus allow the secure sharing of network security credentials to allow a device to connect to a network. By sharing the security credentials out of band, using a different communications protocol (such as Bluetooth or Bluetooth Low Energy), devices can be easily and securely connected to the network.

### BRIEF DESCRIPTION OF THE DRAWINGS

For a better understanding of the present invention, and to show more clearly how it may be carried into effect, reference will now be made, by way of example, to the following drawings, in which:

FIG. 1 shows a system according to embodiments of the invention;

FIG. 2 shows a signalling diagram according to embodiments of the invention; and FIG. 3 shows a signalling diagram according to further embodiments of the invention.

### DETAILED DESCRIPTION

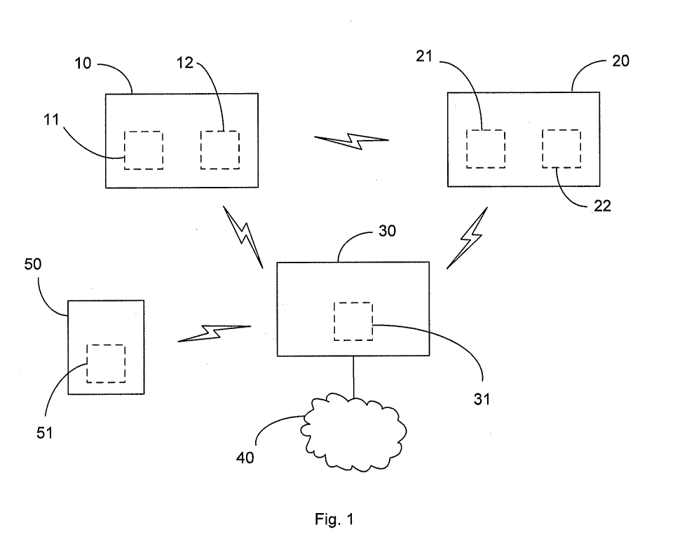

FIG. 1 shows a wireless telecommunications system according to embodiments of the invention, which comprises a first wireless communications device 10, a second wireless communications device 20, a third wireless communications device 50 and an access point 30. The access point 30 provides a connection to a network 40 such as the Internet.

In the illustrated embodiment, the first and second devices 10, 20 each have a first radio 11, 21 suitable for communicating wirelessly according to a first communications protocol, and a second radio 12, 22 for communicating wirelessly according to a second communications protocol. The first communications protocol may allow direct communication between the two wireless devices. For example, the first protocol may be a short-range wireless communications protocol such as Bluetooth or Bluetooth Low Energy. The second communications protocol may be a wireless communications protocol such as WiFi, i.e. any protocol based on the 802.11 standards. The third device 50 possesses a radio 52 for communicating wirelessly according to the second communications protocol, but is not capable of communicating by the first communications protocol.

The access point 30 communicates wirelessly with devices 10, 20, 50 (and other devices not shown) using the second communications protocol to provide a connection to the network 40, and it possesses a radio 32 suitable for wirelessly communicating according to that protocol. In order to establish a connection with the access point 30, it is generally necessary to possess the correct security credentials. That is, communications between the access point 30 and the devices 10, 20, 50 are encrypted, and in order to decrypt them and access the network 40 security credentials are required. The security credentials may comprise at least a password or passphrase (having any number of characters and one or more character types). The security credentials may additionally include the identity of the access point 30, e.g. the service set identification (SSID). Conventionally the security credentials, or at least the password/passphrase, are manually entered into the device 10, 20, 50 by the user of that device. The credentials can then be stored locally in a memory of the device, and used for future connections to the access point 30. However, the manual input of a password or passphrase can be prone to error, leading to repeated failed attempts to connect to the access point 30. The manual input of a password or passphrase may also be difficult if the device 10, 20, 50 has no standard user input device, such as a keyboard. According to embodiments of the present invention, security credentials of a connection to the access point 30 can be shared directly from one wireless device to another.

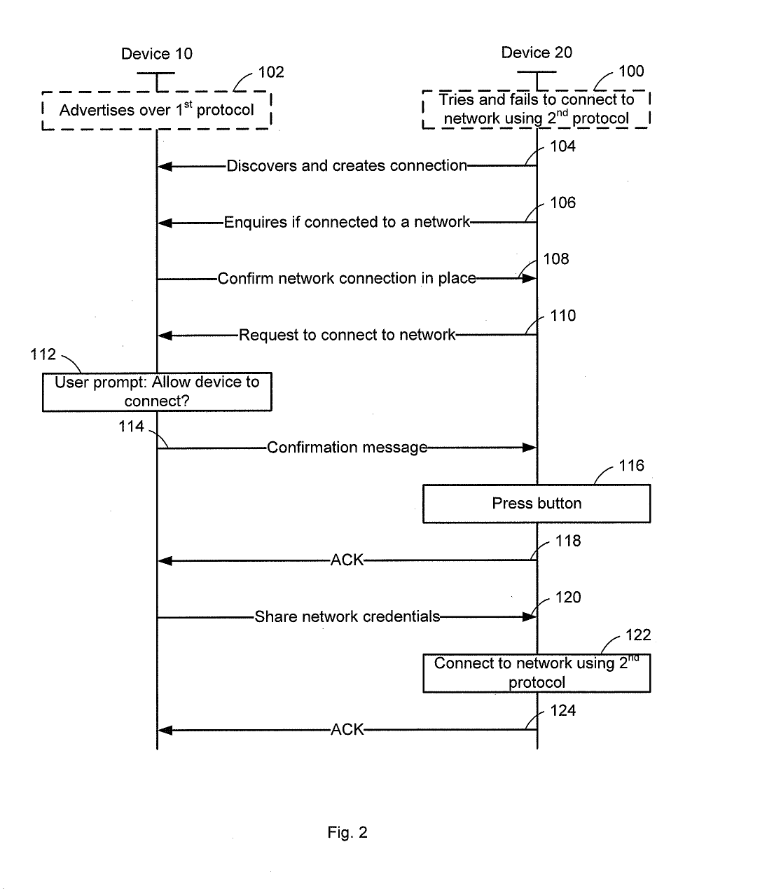

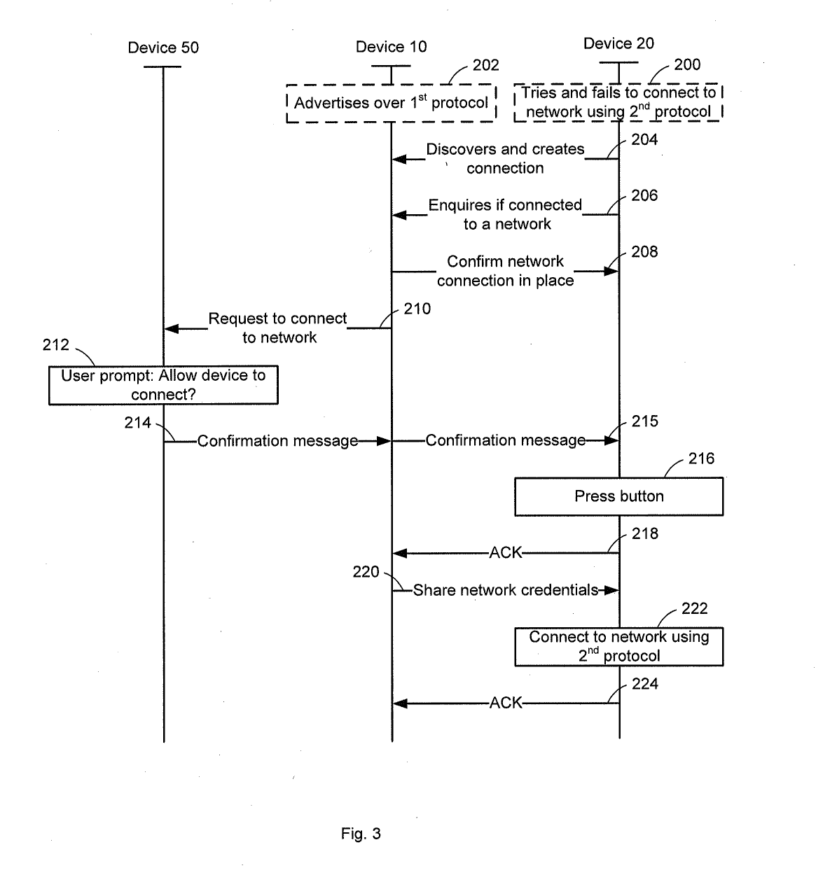

FIG. 2 is a signalling diagram showing a method according to embodiments of the invention, between the two devices 10, 20. In the methods which follow, device 10 is already connected to the network via access point 30, while device 20 is attempting to connect to the network. Unless otherwise stated, the messages between the two devices are carried out using the first communications protocol.

In step 100, the second device 20 optionally attempts but fails to connect to the access point 30 using the second communications protocol. The second device 20 may attempt to connect to the access point 30 automatically upon being powered on. The failure to connect may be due to any reason such as, for example, a mistyped or unknown passphrase, or an inability to discover the access point 30 wirelessly. The failure to connect may prompt the second device 20 to carry out the remaining steps of the method; that is, the second device 20 may only use a method according to embodiments of the invention if it has previously failed to connect to the access point 30. Alternatively, the second device 20 may employ a method according to embodiments of the invention without first attempting to connect to the access point 30 directly.

In step 102, also optionally, the first device 10 advertises its presence using the first communications protocol. For example, the first device may wirelessly transmit one or more messages containing one or more of the device name, the device class, and technical information associated with the device. Such advertisements may be transmitted periodically, and it will be apparent to those skilled in the art that step 102 can occur at the same time, before or after the second device attempts to connect to the network in step 100.

In step 104, the second device 20 discovers the first device 10 and establishes a connection with the first device using the first communications protocol. In embodiments where the first device 10 advertises its presence, the second device 20 may receive one or more advertising messages and respond in order to establish a connection. In other embodiments, the second device 20 may transmit one or more enquiry messages using the first communications protocol in order to discover nearby devices. The first device 10 may respond to those inquiry messages with information such as the device name, device class and technical information (as described above) in order to establish a connection with the second device 20.

Once the connection between the two devices 10, 20 is established using the first communications protocol, in step 106 the second device 20 transmits a message enquiring whether the first device 10 is connected to an access point. The enquiry message may identify a specific access point (such as the access point 30), for example by including an

SSID within the enquiry message; alternatively the enquiry message may simply enquire whether the first device 10 is connected to any access point, without specifying a particular device.

In the illustrated embodiment, the first device 10 is indeed connected to the access point 30, and it therefore transmits a response message to the second device 20 confirming that status in step 108. If the enquiry message identified the particular access point 30, the response message need not contain any further information. If the enquiry message did not identify any particular access point, the response message may optionally contain the identity of the access point 30 (such as the SSID).

In step 110, the second device 20 transmits a message to the first device 10, requesting to connect to the access point 30. In step 112, the user of the first device 10 is prompted as to whether he or she wishes to allow the second device 20 to connect to the access point 30. This may occur by a variety of means, but in one example a suitable message may be displayed on the first device 10, to which the user can respond by any input method. The message may include the identity of the device requesting the connection. Note that the access point 30 may be private to the user of the first device 10, and therefore he or she may not wish to allow other devices to connect.

In this instance, the user of the first device 10 does wish to allow the second device 20 to connect, and therefore in response to the user input a message is sent from the first device 10 to the second device 20 confirming that fact (step 114). The user of the second device 20 is prompted to input a further confirmation that the second device 20 wishes to connect to the access point 30 (step 116). This may simply correspond to the press of a button in response to some stimulus, e.g. a flashing light. Once the input is made, the second device 20 sends a confirmation message (such as an Acknowledgement message) to the first device 10 (step 118).

The purpose of steps 116 and 118 is to confirm that the correct device is being allowed to connect to the access point 30. Up until step 116, the method within the second device 20 may be entirely automated. That is, the second device 20 may automatically communicate with the first device 10 and attempt to establish a connection with the access point 30. The user of the second device 20 may therefore be unaware that it is attempting to connect to the access point 30 and the prompt in step 116 allows the user to confirm that connection.

Further, in some embodiments it is expected that the user of the first device 10 will be the same as the user of the second device 20. That is, the same user is attempting to connect multiple devices to the same access point 30. If the prompt shown in step 112 does not include the identity of the second device 20, the user may be unaware of which device is being connected to the access point 30. The user prompt and confirmation message in steps 116 and 118 serve to confirm that it is the second device 20 which is being allowed to connect to the access point 30.

Once the confirmation message is received, the first device 10 shares the security credentials of its connection to the access point 30 with the second device 20 (step 120). In an embodiment, the security credentials may comprise a password or passphrase. The security credentials may further comprise the identity of the access point 30, such as its SSID. Other credentials may also be shared.

In step 122, the second device 20 uses those security credentials to connect to the access point 30 using the second communications protocol. Once connected, the second device 20 sends a confirmation acknowledgement message to the first device 10 confirming that the connection has been successful.

In some embodiments, it may happen that the user is operating a device which is unable to communicate using the first communications protocol, e.g. device 50. FIG. 3 is a signalling diagram showing a method according to further embodiments of the invention, between the devices 50, 10, 20. In the methods which follow, devices 10, 50 are already connected to the network via access point 30, while device 20 is attempting to connect to the network. Device 10 acts as an intermediary between devices 20 and 50. Unless otherwise stated, the messages between the devices 10, 20 are carried out using the first communications protocol, while communications between the devices 50, 10 are carried out using the second communications protocol; that is, communications between the device 50 and the intermediate device 10 may travel via the access point 30.

The method is largely similar to that described with respect to FIG. 2, with the exception that the user control aspects of the invention reside on a device 50 which is unable to communicate using the first communications protocol. Thus the method steps 200, 202, 204, 206 and 208 are the same as steps 100, 102, 104, 106 and 108 respectively.

In the next step 210, the intermediate device 10 forwards a message to device 50, using the second communications protocol, informing the user of the device 50 that a device 20 wishes to connect to the network via access point 30. The message may contain the identity of the device 20 wishing to connect, but it also may simply indicate that a device wishes to connect without specifying the identity of that device.

In step 212, the user of the device 50 is prompted as to whether he or she wishes to allow the second device 20 to connect to the access point 30. This may occur by a variety of means, but in one example a suitable message may be displayed on the first device 10, to which the user can respond by any input method. The message may include the identity of the device requesting the connection.

In this instance, the user of the device 50 does wish to allow the second device 20 to connect, and therefore in response to the user input a message is sent from the device 50 to the intermediate device 10 (step 214), which then forwards the message to the second device 20 confirming that fact (step 215). Thereafter, steps 216, 218, 220, 222 and 224 are identical to steps 116, 118, 120, 122 and 124 respectively.

In some embodiments, and in either of the signalling diagrams of FIGS. 2 and 3, steps not requiring a user input may be carried out automatically by the devices 10, 20, 50. That is, steps 100, 102, 104, 106, 108, 110, 200, 202, 204, 206, 208 and 210 may all happen automatically without user input. For example, the steps carried out by the connecting device 20 may all happen once the device is switched on. Alternatively, the connecting device 20 may carry out the steps in response to a determination that it is not connected to a network. It is envisaged that embodiments of the present invention have particular applicability where the connecting device (i.e. the second device 20 in the signalling diagrams of FIGS. 2 and 3) is a non-conventional wireless device and does not possess a conventional user interface for inputting complex passwords and passphrases. For example, the second device 20 may be a speaker, a digital photo frame or other media player, a wireless hard drive, or a camera. In contrast, the device allowing the connection to the network (i.e. device 10 in the embodiment of FIG. 2, device 50 in the embodiment of FIG. 3) may be a computing device with such conventional user input means, e.g. a smart phone, a tablet computer, a laptop or a desk top computer. Embodiments of the present invention may be embodied in software, as code on a computer readable medium. For example, the software may be downloaded from the network 40 as an application, to the device allowing the connection to the network.

Embodiments of the present invention thus allow the secure sharing of network security credentials to allow a device to connect to a network. By sharing the security credentials out of band, using a different communications protocol (such as Bluetooth or Bluetooth Low Energy), devices can be easily and securely connected to the network.

Those skilled in the art will appreciate that various amendments and alterations can be made to the embodiments described above without departing from the scope of the invention as defined in the claims appended hereto.

1. A method in a first wireless communication device, comprising:
establishing a first wireless connection with a second wireless communication device using a first communication protocol;
enquiring over the first wireless connection if the second device is connected to a network via a second communication protocol;
if the second device is connected to a network via the second communication protocol, receiving, over the first wireless connection, security credentials of the connection between the second device and the network; and
using the security credentials to establish a second wireless connection with the network using the second communication protocol.

2. A method in a second wireless communication device, comprising:
establishing a first wireless connection with a first device using a first communication protocol;
receiving a message from the first device enquiring whether the second wireless communication device has a second wireless connection to a network via a second communication protocol; and
checking whether the second wireless communication device has the second wireless connection and, if so, sending the security credentials of the second wireless connection to the first device using the first communication protocol.

3. The method as claimed in claim 2, further comprising:
checking whether the second wireless communication device is authorised to release the security credentials; and
only sending the security credentials to the first device if the second wireless communication device is authorised.

4. The method as claimed in claim 3, wherein the step of checking comprises:
displaying a query message to a user of the second wireless communication device; and
receiving a response from the user authorising release of the security credentials.

5. The method as claimed in claim 1, wherein the first communication protocol is Bluetooth or Bluetooth Low Energy.

6. The method as claimed in claim 1, wherein the second communication protocol is an IEEE 802.11 protocol.

7. The method as claimed in claim 1, wherein the security credentials comprise at least a password for connecting to the network.

8. The method as claimed in claim 2, wherein the first communication protocol is Bluetooth or Bluetooth Low Energy.

9. The method as claimed in claim 2, wherein the second communication protocol is an IEEE 802.11 protocol.

10. The method as claimed in claim 2, wherein the security credentials comprise at least a password for connecting to the network.

11. A communications device, comprising:
a first radio for communicating with a second wireless communication device using a first communication protocol; and
a second radio for communicating with a network using a second communication protocol;
the communications device being configured to:
use the first radio to enquire whether the second device is connected to a network via the second communication protocol;
if the second device is connected to a network via the second communication protocol, receive, using the first radio, security credentials of the connection between the second device and the network; and
use the security credentials and the second radio to establish a wireless connection with the network using the second communication protocol.

12. A communications device, comprising:
a first radio for communicating with a second wireless communication device using a first communication protocol; and
a second radio for communicating with a network using a second communication protocol;
the communications device being configured to:
use the first radio to receive a message from the second wireless communication device enquiring whether the communications device has a wireless connection to a network via the second communication protocol; and
check whether the communications device has the wireless connection and, if so, send the security credentials of the wireless connection to the first device using the first communication protocol.

13. The communications device as claimed in claim 12, further configured to:
check whether the communications device is authorised to release the security credentials; and
only send the security credentials to the first device if the second wireless communication device is authorised.

14. The communications device as claimed in claim 13, further configured to:
display a query message to a user of the communications device; and
receive a response from the user authorising release of the security credentials.

15. The communications device as claimed in claim 11, wherein the first communication protocol is Bluetooth or Bluetooth Low Energy.

16. The communications device as claimed in claim 11, wherein the second communication protocol is an IEEE 802.11 protocol.

17. The communications device as claimed in claim 11, wherein the security credentials comprise at least a password for connecting to the network.

18. The communications device as claimed in claim 12, wherein the first communication protocol is Bluetooth or Bluetooth Low Energy.

19. The communications device as claimed in claim 12, wherein the second communication protocol is an IEEE 802.11 protocol.

20. The communications device as claimed in claim 12, wherein the security credentials comprise at least a password for connecting to the network.
